(19) United States
(12) Patent Application Publication
(10) Pub. No.: US 2008/0239927 A1
(43) Pub. Date: Oct. 2, 2008

(54) OPTICAL HEAD DEVICE

(75) Inventors: Masaki Sasaki, Nagano (JP); Izumi Komatsu, Nagano (JP); Tadashi Takeda, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/058,962

(22) Filed: Mar. 31, 2008

(30) Foreign Application Priority Data
Mar. 30, 2007 (JP) JP2007-93482

(51) Int. Cl. G11B 7/135

(52) U.S. Cl. 369/112.16

(57) ABSTRACT

An optical head device may include a polarization conversion element disposed on a common optical path for guiding a first and a second laser beams to a common objective lens for converting the first and the second laser beams to a circularly polarized light from a linearly polarized light, and a ½-wavelength plate disposed on an optical path of the first laser beam from a first laser light source to the common optical path for adjusting a polarization plane direction of the first laser beam. A polarization plane direction of the first laser beam incident on the polarization conversion element from the first laser light source is adjusted by the ½-wavelength plate in a direction so that the linearly polarized light is converted into the circularly polarized light.

### CROSS REFERENCE TO RELATED APPLICATION

The present invention claims priority under 35 U.S.C. §119 to Japanese Application No. 2007-93482 filed Mar. 30, 2007, which is incorporated herein by reference.

### FIELD OF THE INVENTION

An embodiment of the present invention may relate to an optical head device for performing reproduction and/or recording from and/or into an optical recording medium such as a CD or a DVD.

### BACKGROUND OF THE INVENTION

An optical head device which is used for performing reproduction and/or recording from and/or into an optical recording medium such as a CD and a DVD whose thicknesses are different from each other is provided with two sets of laser light sources whose wavelengths are different from each other. In the optical head device, a laser beam emitted from each of the laser light sources is guided to a common optical path and converged on an optical recording medium through a common objective lens. A return light beam component of the laser beam from the optical recording medium is separated on the common optical path from an emitted side laser beam and guided to a light receiving element. Two beam splitters are used in order to guide the respective laser beams to the common optical path and to separate the return light beam component of the respective laser beams from the emitted side laser beam. In Japanese Patent Laid-Open No. 2002-15456, a two-light source type optical pickup is disclosed in which two pieces of inexpensive parallel-plate type beam splitters are used as a beam splitter instead of a cube type beam splitter (prism).

In the optical pickup disclosed in the above-mentioned Patent Reference, a laser beam for CD recording and reproduction is reflected by a first beam splitter in a parallel-plate shape and guided to an optical recording medium side, and a laser beam for DVD reproduction is reflected by a second beam splitter in a parallel-plate shape and then transmits through the first beam splitter to be guided to an optical recording medium. Respective return light beam components of the laser beams reflected by the optical recording medium successively transmit both the beam splitters to be respectively guided to a light receiving element.

In this Patent Reference, each shape of the beam spots on an optical recording medium of the respective laser beams is ellipse and directions of the elliptic beam spots are set so that the respective laser beams are optimized. For example, a major axis of an elliptic beam spot of a laser beam for DVD reproduction is set at an angle of −10 degrees with respect to a radial direction of an optical recording medium. A major axis of an elliptic beam spot of a laser beam for CD recording and reproduction is set, for example, at an angle of +30 degrees with respect to the radial direction of the optical recording medium. It has been qualitatively known that as the angle formed by the major axis of the elliptic beam spot and the radial direction of the optical recording medium becomes smaller, jitter performance becomes superior but a cross talk with adjacent tracks becomes inferior.

The elliptic beam spot of the laser beam for CD recording and reproduction is commonly set to be a larger angle with respect to the radial direction of the optical recording medium than the angle for the elliptic beam spot of the laser beam for DVD reproduction. In other words, the elliptic beam spot of the laser beam for CD recording and reproduction is designed so as to give priority to a cross talk reduction with adjacent tracks. Generally, the angle of the elliptic beam spot is required to be optimally designed according to important characteristics to be considered, for example, according to application of the optical head device, e.g., a cross talk with adjacent tracks, a jitter performance, a track cross signal performance at a time of seeking, an effective spot size at a time of recording.

On the other hand, it has been known that, when a beam spot is formed on an optical recording medium so as to be close to a circularly polarized light, information reading performance for various optical recording media is improved. Therefore, in an optical head device, it has been commonly designed so that a laser beam emitted from a laser light source is brought into a circularly polarized light as close as possible on an optical path of the laser beam. In Japanese Patent Laid-Open No. Hei 8-77578, a structure is disclosed in which a light beam converged on an optical disk is converted to a circularly polarized light by using a ¼-wavelength plate.

In order to convert a laser beam which is a linearly polarized light into a circularly polarized light, directions of polarization plane of respective laser beams which are incident on a polarization conversion element disposed for this purpose are required to be adjusted so as to be set in a specified direction. However, when the respective laser beams are polarized to a circularly polarized light by using a common polarization conversion element, the following problems are required to be solved.

In other words, when directions of elliptic beam spots of the respective laser beams on an optical recording medium are set to be different directions from each other, a laser light source is adjusted around an optical axis and the direction of the elliptic beam spot of the laser beam is set in a prescribed direction. Therefore, the direction of the polarization plane of the laser beam is occasionally set in a direction different from the prescribed direction to the polarization conversion element. In this case, either adjustment of the direction of elliptic beam spot or adjustment of the direction of the polarization plane is obliged to sacrifice and thus optical reading performance decreases.

### SUMMARY OF THE INVENTION

In view of the problems described above, an embodiment of the present invention may advantageously provide an optical head device which is capable of achieving both adjustments of directions of elliptic beam spots of respective laser beams on an optical recording medium and adjustments of polarization plane directions of the respective laser beams which are incident on an polarization conversion element for converting a linearly polarized light into a circularly polarized light.

Thus, according to an embodiment of the present invention, there may be provided an optical head device including a first laser light source which emits a first laser beam, a second laser light source which emits a second laser beam whose wavelength is different from a wavelength of the first laser beam, a common objective lens for converging the first laser beam and the second laser beam on an optical recording medium as an elliptic light spot, a polarization conversion element which is disposed on a common optical path for guiding the first and the second laser beams to the common objective lens and which converts the first and the second laser beams to a circularly polarized light from a linearly polarized light, and a ½-wavelength plate which is disposed on an optical path for the first laser beam from the first laser light source to the common optical path for adjusting a polarization plane direction of the first laser beam. In this optical head device, the first laser light source is disposed in an adjusted state around an optical axis so that an angle between a major axis direction of the elliptic light spot of the first laser beam formed on the optical recording medium and a radial direction of the optical recording medium is set to be a first predetermined angle, and a polarization plane direction of the first laser beam which is incident on the polarization conversion element from the first laser light source is adjusted by the ½-wavelength plate in a direction so that the linearly polarized light is converted into the circularly polarized light. Further, the second laser light source is disposed so that an angle between a major axis direction of the elliptic light spot of the second laser beam formed on the optical recording medium and the radial direction of the optical recording medium is set to be a second predetermined angle, and the second laser light source is adjusted around an optical axis so that a polarization plane direction of the second laser beam which is incident on the polarization conversion element is set in a direction where the linearly polarized light is converted into the circularly polarized light.

In the optical head device having the structure described above, a polarization conversion element such as a directing mirror is disposed on the common optical path for the first and the second laser beams to convert the first and the second laser beams to a circularly polarized light, and the polarization plane direction of one of the laser beams is adjusted by the ½-wavelength plate.

Therefore, according to the embodiment described above, the directions of the elliptic beam spots of the respective laser beams on the optical recording medium can be set separately and, moreover, the respective laser beams are incident on the common polarization conversion element in the state that the polarization planes of the respective laser beams are set in the prescribed direction and converted into the circularly polarized light and then converged on the optical recording medium. Accordingly, both adjustments of directions of the elliptic beam spots of the respective laser beams, on the optical recording medium and adjustments of polarization plane directions of the respective laser beams which are incident on the polarization conversion element for converting a linearly polarized light into a circularly polarized light are achieved and thus a two-wavelength type optical head device in which an optical reading characteristic is superior can be realized.

In accordance with an embodiment of the present invention, a directing mirror which totally reflects the first and the second laser beams to the objective lens is used as the polarization conversion element. According to this structure, a size and cost of the device can be reduced. In this case, a reflection layer of the directing mirror is preferably set so that phase differences at the time of reflection of the first and the second laser beams are set to be π(2n+1)/2 (n=0, 1, 2, 3 . . . ), and the first and the second laser beams are incident on the reflection face of the directing mirror so that polarization plane directions of the first and the second laser beams are inclined at 45 degrees with respect to a perpendicular plane including an incidence direction and a reflection direction on and from the reflection face of the directing mirror. Specifically, the first laser beam may be a laser beam with a wavelength of 780 nm band for a CD system disk, and the second laser beam may be a laser beam with a wavelength of 650 nm band for a DVD system disk.

In an optical head device, a diffraction grating may be disposed on an optical path of the first laser beam from the first laser light source to the common optical path for dividing the first laser beam into three beams. In this case, it is preferable that the ½-wavelength plate for causing a polarization plane direction of the first laser beam to be incident on the reflection face of the directing mirror at 45 degrees is integrally formed with the diffraction grating for reducing the size and cost of the device.

In accordance with an embodiment of the present invention, the optical head device further includes a light receiving element which receives each of return light beam components of the first and the second laser beams which are reflected by the optical recording medium and returned through the common optical path, a first beam splitter in a parallel-plate shape which is disposed so as to guide the first and the second laser beams to the common optical path and to guide the return light beam component through the common optical path to the light receiving element, a second beam splitter in a parallel-plate shape which is disposed so as to guide the second laser beams to the common optical path and to guide the return light beam component through the common optical path to the light receiving element, and an aberration correction lens such as a toric lens which is disposed between the first laser light source and the first beam splitter for correcting an aberration which occurs when the first laser beam transmits through the first beam splitter. The optical head device is structured so that the first laser beam which is emitted from the first laser light source is partially transmitted through the first beam splitter in an obliquely direction to be guided to the objective lens, and the second laser beam which is emitted from the second laser light source is sequentially reflected by the second beam splitter and the first beam splitter to be guided to the objective lens, and each of the return light beam components of the first laser beam and the second laser beam is reflected by the first beam splitter to be guided to the second beam splitter and then transmits through the second beam splitter to be guided to the light receiving element. In this case, it is preferable that the first laser light source and the aberration correction lens are fixed to a common holder in an aligned state where respective positions of the first laser light source and the aberration correction lens are aligned with each other and they structure a piece of light source unit.

Further, it is preferable that an incident angle of the first laser beam to the first beam splitter is set at an inclination angle of less than 45° to reduce an astigmatism and a coma aberration which occur when the first laser beam transmits through the first beam splitter.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(A) is a plan view showing an optical head device in accordance with an embodiment of the present invention, FIG. 1(B) is its side view, and FIG. 1(C) is a bottom view showing the optical head device from which a bottom cover and like are detached.

FIG. 2 is a schematic optical structure view showing an optical system of the optical head device in FIGS. 1(A) through 1(C).

FIG. 3(A) is an explanatory view showing an optical system of an optical head device 1 and elliptic beam spots of respective laser beams on an optical recording medium, FIG. 3(B) is a partially sectional view showing a part of an optical system, and FIG. 3(C) is an explanatory view showing a polarization plane direction of a laser beam which is incident on a total reflection mirror.

### DETAILED DESCRIPTION OF THE PREFERRED EMBODIMENTS

An optical head device in accordance with an embodiment of the present invention will be described below with reference to the accompanying drawings.

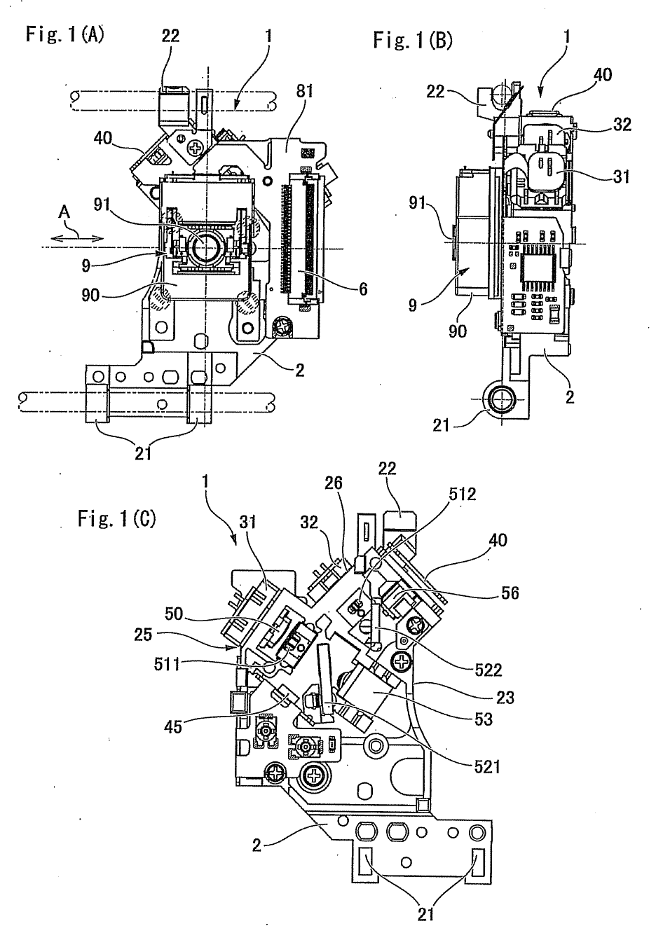

FIG. 1(A) is a plan view showing an optical head device in accordance with an embodiment of the present invention, FIG. 1(B) is its side view, and FIG. 1(C) is a bottom view showing the optical head device from which a bottom cover and like are detached. An optical head device 1 in this embodiment is a two-wavelength optical head device in which recording or reproduction of information into or from a CD system disk and a DVD system disk is capable of performing by using a first laser beam with a wavelength of 780 nm band and a second laser beam with a wavelength of 650 nm band.

The optical head device 1 includes a device frame 2 which is formed of a die casting product made of metal such as magnesium or zinc or which is made of resin. Respective end portions of the device frame 2 are formed with a first bearing part 21 and a second bearing part 22 which are engaged with a guide shaft and a feed screw shaft of a disk drive device (portions shown by the imaginary line in FIG. 1(A)). In this manner, the optical head device 1 is reciprocatingly movable in a radial direction of a disk as shown by the arrow

An objective lens 91 is disposed at a roughly center portion on an upper face side of the device frame 2. Further, the device frame 2 is mounted with an objective lens drive mechanism 9 for servo-controlling a position of the objective lens 91 in a focusing direction and a tracking direction. In the optical head device 1 in this embodiment, recording and reproduction are performed with the first laser beam and the second laser beam through the common objective lens 91. Therefore, a two-wavelength lens on which a diffraction grating with concentric circular grooves or steps is formed is used as the objective lens 91.

For example, a wire suspension type mechanism which is well known is used as the objective lens drive mechanism 9. Detailed description of the objective lens drive mechanism 9 is omitted but the objective lens drive mechanism 9 includes a lens holder which holds the objective lens 91, a holder support portion which movably supports the lens holder in the tracking direction and the focusing direction with a plurality of wires, and a yoke which is fixed to the device frame 2. Further, the objective lens drive mechanism 9 is provided with a magnetic drive circuit which is structured of drive coils mounted on the lens holder and drive magnets which are mounted on the yoke. The objective lens 91 which is held on the lens holder is driven in the tracking direction and the focusing direction with respect to the optical recording medium by controlling energization to the drive coils. Further, the objective lens drive mechanism 9 is also capable of performing tilt control for adjusting inclination in a jitter direction of the objective lens 91. In this embodiment, surroundings of the objective lens 91 are covered with a rectangular frame-shaped actuator cover 90.

The device frame 2 is provided with a flexible circuit board 81 on which a connector 6 and the like are mounted. Power supply, signal supply and the like are performed to the first and the second laser light sources 31 and 32 and the light receiving element 40 for signal detection through the flexible circuit board 81.

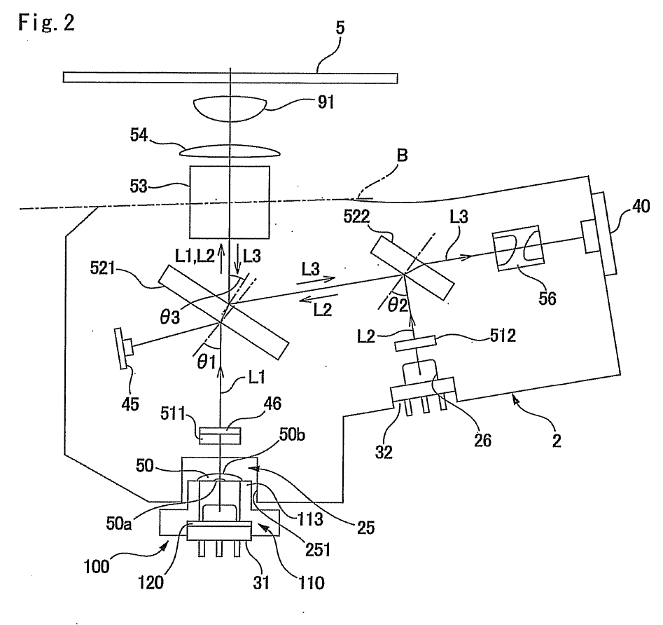

FIG. 2 is a schematic optical structure view showing an optical system of the optical head device 1. The upper portion from the position shown by the alternate long and short dash line “B” is a portion which is arranged in a direction perpendicular to the paper but, in FIG. 2, the upper portion is shown in a flatly developed state.

As shown in FIG. 1(C) and FIG. 2, the device frame 2 is mounted with the first laser light source 31 provided with an AlGaInP-based laser diode for emitting the first laser beam and the second laser light source 32 provided with an AlGaAs-based laser diode for emitting the second laser beam. The first laser light source 31 is structured as a piece of unit and mounted to a unit mounting part 25 which is formed in the device frame 2. After positional adjustment of the first laser light source 31 has been performed, the first laser light source 31 is adhesively bonded and fixed to the device frame 2. On the other hand, the second laser light source 32 is press-fitted and fixed to a press fitting part 26 which is formed in the device frame 2.

A first forward path “L1” along which the first laser beam is guided to a recording face of the optical recording medium 5 from the first laser light source 31 and a second forward path “L2” along which the second laser beam is guided to the recording face of the optical recording medium 5 from the second laser light source 32 are formed as optical paths for the first and the second laser beams. Further, a return path “L3” is formed along which a return light beam which is reflected by the recording face of the optical recording medium 5 is guided to the light receiving element 40 for signal detection.

On the first forward path “L1” are disposed a first diffraction grating 511 for diffracting the first laser beam emitted from the first laser light source 31 to three beams for tracking detection, a first beam splitter 521 in a parallel plate shape for partially transmitting the laser beams divided into three beams by the first diffraction grating 511, and a directing mirror 53 for directing the laser beams transmitting through the first beam splitter 521 upward to the optical recording medium 5. A collimating lens 54 for forming the laser beam into a parallel light and the objective lens 91 for converging the parallel light from the collimating lens 54 on the recording face of the optical recording medium 5 are disposed on an upper position of the directing mirror 53.

On the second forward path “L2” are disposed a second diffraction grating 512 for diffracting the second laser beam emitted from the second laser light source 32 into three beams for tracking detection and a second beam splitter 522 in a parallel-plate shape for partially reflecting the laser beams divided into three beams by the second diffraction grating 512.

The first beam splitter 521 formed in the parallel-plate shape is used as an optical path composite element for composing the first forward path “L1” and the second forward path “L2”. The laser beam which is reflected by the second beam splitter 522 is partially reflected by the first beam splitter 521 and then, similarly to the first laser beam, the laser beam is irradiated on the recording face of the optical recording medium 5 through the directing mirror 53, the collimating lens 54 and the objective lens 91. Therefore, an optical path from the first beam splitter 521 to the optical recording medium 5 is structured as a common optical path.

The return light beam along the return path “L3” returns to the first beam splitter 521 through the common optical path. After the return light beam is reflected by the first beam splitter 521, the return light beam transmits through the second beam splitter 522 and then, an astigmatism is applied to the return light beam by the detection lens 56 and the return light beam reaches to the light receiving element 40 for signal detection.

In this embodiment, as shown in FIG. 1(C) and FIG. 2, a light receiving element 45 for monitor is disposed at a vicinity position of an incidence face of the first beam splitter 521 to which the first laser beam is incident. A reflected light component of the first laser beam which is partially reflected by the incident face of the first beam splitter 521 is received with the light receiving element 45 for monitor and, on the basis of quantity of the received light, an emission intensity of the first laser light source can be feedback-controlled.

Therefore, the first beam splitter 521 in this embodiment is provided with an optical characteristic that substantially 50% of the first laser beam is transmitted and substantially 50% is reflected and that the second laser beam is substantially totally reflected. The second beam splitter 522 is provided with an optical characteristic that the first laser beam is substantially totally transmitted and substantially 50% of the second laser beam is transmitted and substantially 50% is reflected.

An aberration correction lens 50 for correcting aberration is disposed between the first laser light source 31 and the first diffraction grating 511 on the first forward path “L1”. The aberration correction lens 50 is a lens for correcting aberration (coma aberration and astigmatism) which occurs when the first laser beam emitted from the first laser light source 31 is diagonally transmitted through the first beam splitter 521 as a divergent beam. A toric lens is, for example, used as the aberration correction lens 50. The toric lens is structured so that a lens face on a side of the first laser light source 31 is formed to be a concave face 50a and a lens face on the other side is formed to be a toric face 50b.

The first laser light source 31 and the aberration correction lens 50 are fixed to a common holder 110 to structure a piece of light source unit 100. The light source unit 100 is mounted on a unit mounting part 25 of the device frame 2.

The aberration correction lens 50 (toric lens) is disposed in an inclined state by a specified angle with respect to an emitting beam axis of the first laser light source 31. The concave face 50a and the toric face 50b are inclined by the specified angle with respect to the optical axis of the emitted light beam of the first laser light source 31. The aberration correction lens 50 generates coma aberration in a reverse direction to coma aberration, which is generated when the first laser beam transmits through the first beam splitter 521, by the inclinations of the concave face 50a and the toric face 50b with respect to the optical center axis of the first laser beam. As a result, the coma aberration generated when the first laser beam transmits through the first beam splitter 521 is corrected. Further, the aberration correction lens 50 generates coma aberration in a reverse direction to astigmatism, which is generated when the first laser beam transmits through the first beam splitter 521, by anisotropy of radius of curvature of the toric face 50b. As a result, the astigmatism when the first laser beam transmits through the first beam splitter 521 is corrected.

In this embodiment, an optical magnifying power in the second forward path “L2” directing to an optical recording medium 5 from the second laser light source 32 is, for example, set to be in a range of from 6.5 to 7.5 (6.5-7.5) times. On the other hand, an optical magnifying power in the first forward path “L1” directing to the optical recording medium from the first laser light source 31 is, for example, preferably set to be in a range of from 3.5 to 5.0 (3.5-5.0) times. However, in the first forward path “L1” and the second forward path “L2”, the collimating lens 54 and the objective lens 91 are commonly used and there is a limitation on layout too. Therefore, the toric lens which is used as the aberration correction lens 50 is also used as a magnifying power conversion lens for the first laser beam to optimize the optical magnifying power in the first forward path “L1” directing to the optical recording medium 5 from the first laser light source 31 by the aberration correction lens 50 (toric lens).

Further, an incident angle θ1 of the first laser beam to the first beam splitter 521 is set at an inclination angle of less than 45°. For example, the incident angle θ1 is set at 40°. Therefore, a length of an optical path where the first laser beam transmitting through the first beam splitter 521 is shortened and thus aberration, which is generated when the first laser beam transmits through the first beam splitter 521, becomes smaller by a quantity of the incident angle which is set to be nearer to the vertical incidence to the first beam splitter 521. In this embodiment, the incident angle θ2 to the second beam splitter 522 of the second laser beam is set to be 45°. However, an incident angle θ3 of the second laser beam to the first beam splitter 521 is set to be at the same angle as the incident angle θ1 of the first laser beam to the first beam splitter 521, for example, set to be at 40°.

The diffraction grating 511 for generating three beams which is disposed on the first forward path “L1” is stuck with a ½-wavelength plate 46 on its emitting side face. A polarization direction of the first laser beam emitted from the first laser light source 31 is adjusted by the ½-wavelength plate 46 so that a polarization direction is inclined at 45 degrees to a slope face of the reflection face 53a of the directing mirror 53 including the incidence and the reflection directions when the first laser beam is incident on the reflection face 53a of the directing mirror 53. The reflection face 53a of the directing mirror 53 is formed with a reflection layer or, specifically, a reflection coating which causes a phase difference of n(2n+1)/2 (n−0, 1, 2 . . . ) to generate when both the laser beams are reflected. Therefore, both the laser beams incident on the reflection face 53a of the directing mirror 53 in a state that directions of the polarization planes are inclined at 45 degrees are converted into a circularly polarized light after reflection. Information reading performance is improved by a beam spot which is formed close to a circularly polarized light on an optical recording medium 5.

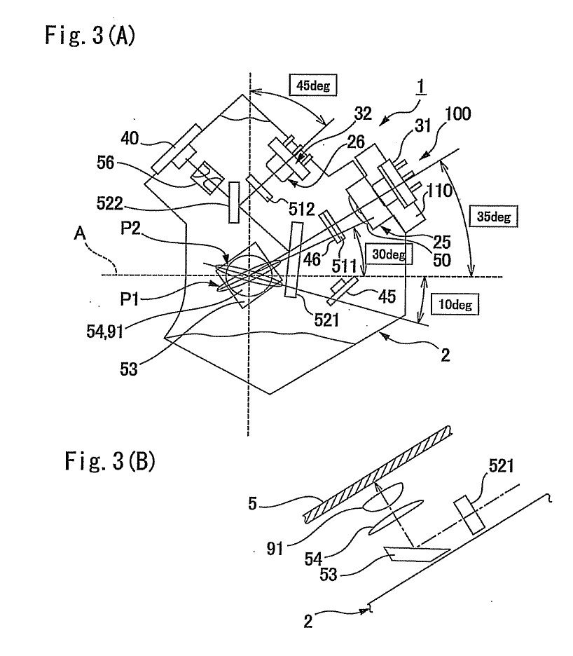

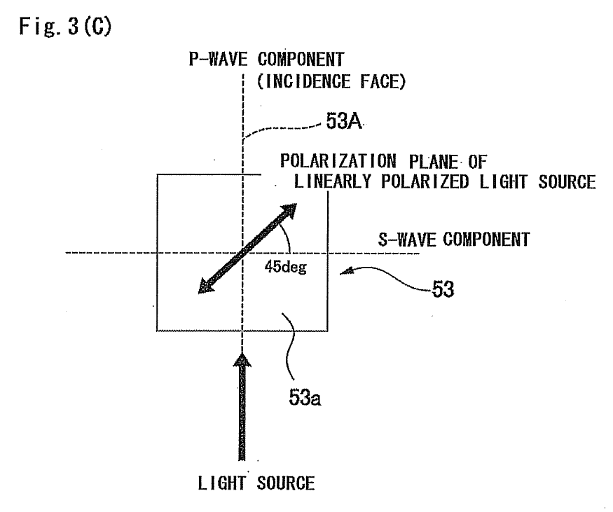

FIG. 3(A) is an explanatory view showing an optical system of the optical head device 1 and elliptic beam spots on an optical recording medium of respective laser beams, FIG. 3(B) is a partially sectional view showing a part of the optical system, and FIG. 3(C) is an explanatory view showing a polarization plane direction of a laser beam which is incident on a total reflection mirror.

Beam spots on an optical recording medium 5 of the first and the second laser beams are elliptic beam spots “P1” and “P2”. Directions of the elliptic beam spots “P1” and “P2” are provided with an angular difference therebetween so that the respective laser beams are optimized. For example, a major axis of the elliptic beam spot “P2” of the second laser beam for a DVD system disk is set, for example, at an angle of −10 degrees with respect to the radial direction “A” of the optical recording medium 5. On the other hand, a major axis of the elliptic beam spot “P1” of the first laser beam for a CD system disk is set, for example, at an angle of +30 degrees with respect to the radial direction “A” of the optical recording medium 5.

It has been qualitatively known that as the angle formed between a major axis of the elliptic beam spot and the radial direction “A” of the optical recording medium becomes smaller, jitter performance becomes superior but a cross talk with adjacent tracks becomes inferior. Therefore, it is designed that the angle of the elliptic beam spot “P1” of the first laser beam for a CD system disk is set to be larger than the angle of the elliptic beam spot “P2” of the second laser beam for a DVD system disk with respect to the radial direction of the optical recording medium 5 to give priority to a cross talk reduction with adjacent tracks.

In order to convert both the laser beams into a circularly polarized light while using the common directing mirror 53, as shown in FIG. 3(C), both the laser beams are required to be designed that polarization planes of the respective laser beams are incident at an angle of 45 degrees with respect to the perpendicular plane 53A including the incidence direction and the reflection direction which is formed on the reflection face 53a of the directing mirror 53.

In this embodiment, the second laser light source 32 is press-fitted and fixed to the device frame 2 in a state that its position is adjusted around the optical axis of the second laser light source 32 so that the polarization plane direction of the second laser beam in an emitted state is incident on the reflection face 53a of the directing mirror 53 at 45 degrees.

On the other hand, the first laser light source 31 is mounted on the device frame 2 in a state that its polarized light direction is adjusted so that the elliptic beam spot “P1” on the optical recording medium 5 of the first laser beam emitted from the first laser light source 31 is set to be at the angle of +30 degrees with respect to the radial direction “A”. Therefore, in this situation, the polarization plane direction is not incident at the angle of 45 degrees to the reflection face 53a of the directing mirror 53 and thus the first laser beam is not converted into a circularly polarized light by the directing mirror 53. In other words, when the first laser beam is set to be at the angle (+30 degrees) which is required for the major axis direction of the elliptic beam spot “P1” on the optical recording medium 5, the angle of the polarization plane direction at the time of incidence of the laser beam to the directing mirror 53 becomes considerably different from 45 degrees.

) Therefore, in this embodiment, the polarization plane direction of the first laser beam emitted from the first laser light source 31 is adjusted by the ½-wavelength plate 46, which is disposed between the first laser light source 31 and the directing mirror 53, so that the polarization plane direction is adjusted so as to be incident on the directing mirror 53 at the angle of 45 degrees.

Further, in this embodiment, the ½-wavelength plate 46 is integrally formed on an emitting face side of the diffraction grating 511 for generating three beams. Therefore, the ½-wavelength plate 46 and the diffraction grating. 511 are integrally formed as a single optical element and thus its size and cost can be reduced.

In this embodiment, the polarization plane direction of the first laser beam is adjusted by the ½-wavelength plate 46 but the polarization plane direction of the second laser beam may be adjusted by a ½-wavelength plate. In other words, the angle of the elliptic beam spot is required to be optimally designed according to characteristics considered to be important, for example, according to application of the optical head device 1 such as a cross talk with adjacent tracks, a jitter performance, a track cross signal performance at the time of seeking, an effective spot size at the time of recording. Therefore, for example, in a case that an angle defined by the elliptic beam spot “P2” of the second laser beam and the radial direction “A” of the optical recording medium 5 is increased, it may be required to adjust the polarization plane of the second laser beam by using a ½-wavelength plate which is disposed on an emitting face side of the diffraction grating 512 for dividing the second laser beam into three beams.

As described above, in the optical head device 1 in this embodiment, the directing mirror 53 for converting the respective laser beams into a circularly polarized light is disposed on the common optical path of the respective laser beams and the polarization plane direction of the first laser beam which is incident on the directing mirror 53 is adjusted by using the ½-wavelength plate 46.

Therefore, the directions of the elliptic beam spots “P1” and “P2” of the respective laser beams on the optical recording medium 5 can be set separately. Moreover, the respective laser beams are incident on the common directing mirror 53 in the state that the respective polarization planes of the laser beams are set to be a prescribed direction and, after having converted into a circularly polarized light, the respective laser beams are converged on the optical recording medium 5. Accordingly, both adjustments of the directions of the elliptic beam spots “P1” and “P2” of the respective laser beams on the optical recording medium 5 and adjustments of the polarization plane directions of the respective laser beams which are incident on the directing mirror 53 for converting a linearly polarized light to a circularly polarized light can be performed. As a result, a two-wavelength type optical head device whose optical reading characteristic is superior can be realized.

Further, in the optical head device 1 in accordance with this embodiment, the following operations and effects are obtained. First, the first beam splitter 521 in a parallel-plate shape is used as an optical path composing element which partially transmits the first laser beam emitted from the first laser light source 31 and partially reflects the second laser beam emitted from the second laser light source 32. Further, the second beam splitter 522 in a parallel-plate shape is used as an optical path separation element for separating the return light beams of the respective laser beams from the emitted laser beam to guide to the light receiving element 40 for signal detection. Therefore, cost can be reduced in comparison with a case when two prisms are used as the optical path composing element and the optical path separation element.

Further, the aberration correction lens 50 for correcting the astigmatism and the coma aberration generated in the first laser beam, which obliquely transmits through the first beam splitter 521 formed in a parallel-plate shape, is disposed on the emitting side of the first laser light source 31. Further, in order to perform accurately aligning the aberration correction lens 50 with the first laser light source 31, the aberration correction lens 50 and the first laser light source 31 are fixed to the common holder 110 to structure a piece of light source unit 100 and, after the position of the light source unit 100 has been adjusted, the light source unit 100 is adhesively bonded and fixed to the device frame 2. The astigmatism and the coma aberration of the first laser beam, which are generated when the first laser beam obliquely transmits through the first beam splitter 521 in a parallel-plate shape, are securely corrected by the aberration correction lens 50 which is structured as one light source unit with the first laser light source 31. Therefore, the aberration can be corrected without using a conventional parallel-plate type beam splitter, which is thin and made of material whose hardness is high, as the beam splitter through which the light beam is transmitted. Accordingly, a satisfactory beam spot can be formed on the optical recording medium 5.

In addition, the light source unit 100 is mounted on the unit mounting part 25 of the device frame 2 in the state that the position of the light source unit 100 is capable of being three-dimensionally adjusted and, after having been three-dimensionally adjusted and positioned, the light source unit 100 is fixed to the device frame 2 with an adhesion. Therefore, remaining aberration of the light source unit 100 can be securely reduced, and positional adjustment with the light receiving element 40 for detection and the like can be accurately performed with a simple adjusting work.

In addition, the aberration correction lens 50 is disposed on the optical path directing to the first beam splitter 521 from the first laser light source 31. Therefore, the aberration correction lens 50 does not affect the second laser beam which is reflected by the first beam splitter 521 in a parallel-plate type and thus optical design of the aberration correction lens 50 can be easily performed.

Further, the incident angle θ1 of the first laser beam to the first beam splitter 521 is set to be less than 45° and thus a length of the optical path where the first laser beam transmits through the first beam splitter 521 can be shortened. Since the first laser beam is incident on the first beam splitter 521 at an angle closer to the vertical incidence, aberration generated when the first laser beam transmits through the first beam splitter 521 can be reduced. Therefore, correcting quantity of the aberration that is performed by the aberration correction lens 50 can be reduced. Further, design of the toric lens that is used for the aberration correction lens 50 becomes easy.

Further, the toric lens which is used as the aberration correction lens 50 is also used as a magnification conversion lens to the first laser beam. Therefore, a magnification conversion lens is not required to provide separately and thus cost can be further reduced.

In addition, when the incident angle θ1 of the first laser beam to the first beam splitter 521 is set to be less than 45°, the first and the second laser light sources 31 and 32 are disposed in a farther separated state even when a size of the device frame 2 is reduced. Therefore, mounting work of the first and the second laser light sources 31 and 32, positional adjustment work of the first and the second laser light sources 31 and 32, and the like can be performed easily. As a comparison example, when the incident angle θ1 of the first laser beam to the first beam splitter 521 is set to be 45°, emitting optical axes of the first and the second laser light sources 31 and 32 are parallel to each other and thus the laser light sources 31 and 32 are located to approach each other. However, when the incident angle θ1 of the first laser beam to the first beam splitter 521 is set to be less than 45°, the emitting beam axis of the second laser light source 32 is inclined to the direction where the laser light sources 31 and 32 are located further apart.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device comprising:
a first laser light source which emits a first laser beam;
a second laser light source which emits a second laser beam whose wavelength is different from a wavelength of the first laser beam;
a common objective lens for converging the first laser beam and the second laser beam on an optical recording medium as an elliptic light spot;
a polarization conversion element which is disposed on a common optical path for guiding the first and the second laser beams to the common objective lens and which converts the first and the second laser beams to a circularly polarized light from a linearly polarized light;
a ½-wavelength plate which is disposed on an optical path of the first laser beam from the first laser light source to the common optical path for adjusting a polarization plane direction of the first laser beam;
wherein the first laser light source is disposed in an adjusted state around an optical axis so that an angle between a major axis direction of the elliptic light spot of the first laser beam formed on the optical recording medium and the radial direction of the optical recording medium is set to be a first predetermined angle, and a polarization plane direction of the first laser beam which is incident on the polarization conversion element from the first laser light source is adjusted by the ½-wavelength plate in a direction so that the linearly polarized light is converted into the circularly polarized light; and
wherein the second laser light source is disposed so that an angle between a major axis direction of the elliptic light spot of the second laser beam formed on the optical recording medium and a radial direction of the optical recording medium is set to be a second predetermined angle, and the second laser light source is adjusted around an optical axis so that a polarization plane direction of the second laser beam which is incident on the polarization conversion element is set in a direction where the linearly polarized light is converted into the circularly polarized light.

2. The optical head device according to claim 1,
wherein the polarization conversion element is a directing mirror which totally reflects the first and the second laser beams to the objective lens;
wherein the directing mirror is provided with a reflection face which is set so that phase differences at the time of reflection of the first and the second laser beams are set to be n(2n+1)/2 (n=0, 1 , 2, 3 . . . ); and
wherein the first and the second laser beams are incident on the directing mirror in a state that polarization plane directions of the first and the second laser beams are inclined at 45 degrees with respect to a perpendicular plane including an incidence direction and a reflection direction on and from the directing mirror.

3. The optical head device according to claim 2, further comprising:
a light receiving element which receives each of return light beam components of the first and the second laser beams which are reflected by the optical recording medium and are returned through the common optical path;
a first beam splitter in a parallel-plate shape which is disposed to guide the first and the second laser beams to the common optical path and to guide the return light beam components through the common optical path to the light receiving element;
a second beam splitter in a parallel-plate shape which is disposed to guide the second laser beam to the common optical path and to guide the return light beam components of the first and the second laser beams through the common optical path to the light receiving element; and
an aberration correction lens which is disposed between the first laser light source and the first beam splitter for correcting an aberration which occurs when the first laser beam transmits through the first beam splitter;
wherein the first laser beam which is emitted from the first laser light source is partially transmitted through the first beam splitter in an oblique direction to be guided to the objective lens;
wherein the second laser beam which is emitted from the second laser light source is sequentially reflected by the second beam splitter and the first beam splitter to be guided to the objective lens; and
each of the return light beam components of the first laser beam and the second laser beam is reflected by the first beam splitter to be guided to the second beam splitter and then transmits through the second splitter to be guided to the light receiving element.

4. The optical head device according to claim 3, wherein a toric lens is used as the aberration correction lens.

5. The optical head device according to claim 3, wherein the first laser light source and the aberration correction lens are fixed to a common holder in an aligned state where respective positions of the first laser light source and the aberration correction lens are aligned with each other to structure a piece of light source unit.

6. The optical head device according to claim 5, wherein
a position of the light source unit provided with the first laser light source is three-dimensionally adjusted and fixed to a device frame, and
the second laser light source is fixed to the device frame in a state that a position of the second laser light source is adjusted around an optical axis of the second laser light source so that a polarization plane direction of the second laser beam is incident on the reflection face of the directing mirror at 45 degrees.

7. The optical head device according to claim 6, further comprising a diffraction grating which is disposed on an optical path of the first laser beam from the first laser light source to the common optical path for dividing the first laser beam into three beams,
wherein the ½-wavelength plate is integrally formed with the diffraction grating, and the polarization plane direction of the first laser beam is adjusted by the ½-wavelength plate so as to be incident on the reflection face of the directing mirror at 45 degrees.

8. The optical head device according to claim 3, wherein the first laser beam is a laser beam with a wavelength of 780 nm band for a CD system disk, and the second laser beam is a laser beam with a wavelength of 650 nm band for a DVD system disk.

9. The optical head device according to claim 1, further comprising;
a light receiving element which receives each of return light beam components of the first and the second laser beams which are reflected by the optical recording medium and are returned through the common optical path;
a first beam splitter in a parallel-plate shape which is disposed to guide the first and the second laser beams to the common optical path and to guide the return light beam components through the common optical path to the light receiving element;
a second beam splitter in a parallel-plate shape which is disposed to guide the second laser beam to the common optical path and to guide the return light beam components of the first and the second laser beams through the common optical path to the light receiving element; and
an aberration correction lens which is disposed between the first laser light source and the first beam splitter for correcting an aberration which occurs when the first laser beam transmits through the first beam splitter;
wherein the first laser beam which is emitted from the first laser light source is partially transmitted through the first beam splitter in an oblique direction to be guided to the objective lens;
wherein the second laser beam which is emitted from the second laser light source is sequentially reflected by the second beam splitter and the first beam splitter to be guided to the objective lens; and
each of the return light beam components of the first laser beam and the second laser beam is reflected by the first beam splitter to be guided to the second beam splitter and then transmits through the second splitter to be guided to the light receiving element.

10. The optical head device according to claim 9, wherein a toric lens is used as the aberration correction lens.

11. The optical head device according to claim 9, wherein the first laser light source and the aberration correction lens are fixed to a common holder in an aligned state where respective positions of the first laser light source and the aberration correction lens are aligned with each other to structure a piece of light source unit.

12. The optical head device according to claim 9, further comprising a diffraction grating which is disposed on an optical path of the first laser beam from the first laser light source to the common optical path for dividing the first laser beam into three beams;
wherein the ½-wavelength plate is integrally formed with the diffraction grating.

13. The optical head device according to claim 9, wherein the first laser beam is a laser beam with a wavelength of 780 nm band for a CD system disk, and the second laser beam is a laser beam with a wavelength of 650 nm band for a DVD system disk.

14. The optical head device according to claim 9, wherein an incident angle of the first laser beam to the first beam splitter is set at an inclination angle of less than 45°.
